(19) United States
(12) Patent Application Publication
(10) Pub. No.: US 2024/0031319 A1
(43) Pub. Date: Jan. 25, 2024

(54) WEBPAGE REDIRECT BASED ON USER INFORMATION

(71) Applicant: PAYPAL, INC., San Jose, CA (US)

(72) Inventor: George Chen Kaidi, San Jose, CA (US)

(21) Appl. No.: 17/869,650

(22) Filed: Jul. 20, 2022

(51) Int. Cl. H04L 51/18; H04L 67/02; H04L 51/234

(52) U.S. Cl. CPC H04L 51/18; H04L 67/02; H04L 51/234

(57) ABSTRACT

A method includes generating, a communication to a user, the communication including content, receiving a user request to serve a first webpage, and determining metadata associated with the request. The method further includes retrieving metadata associated with the communication and determining that the request is from the user according to the metadata associated with the request and according to the metadata associated with the communication. The method further includes transmitting data respective of a second webpage, the second webpage different from the first webpage, in response to determining that the request is from the user, the second webpage associated with the content.

### TECHNICAL FIELD

This disclosure relates to redirecting a user's request for a network resource, such as a webpage, based on information associated with that user.

### BACKGROUND

Electronic communications, such as e-mails, text messages, and in-application messages, may include selectable hyperlinks. For example, an organization may send an email or text message with an offer or information and a selectable hyperlink that the user can click or tap to navigate to a webpage associated with that offer or information.

### BRIEF DESCRIPTION OF THE DRAWINGS

FIG. 1 is a block diagram view of an example networked system for serving a resource-specific webpage to a user.

FIG. 2 is a sequence diagram illustrating an example process for serving a resource-specific webpage to a user.

FIG. 3 is a flow chart illustrating an example method of serving a resource-specific webpage to a user.

FIG. 4 is a flow chart illustrating an example method of serving a resource-specific webpage to a user.

FIG. 5 is a flow chart illustrating an example method of serving a resource-specific webpage to a user.

FIG. 6 is a block diagram of an example computing system.

### DETAILED DESCRIPTION

Known methods and systems for providing direct links to users to desired webpages through communications such as text messages and emails are prone to phishing and other fraudulent practices. For example, a fraudulent third party may send a communication to a user that appears to be from a legitimate source (e.g., by emulating the look and feel of legitimate communications from that source). Such fraudulent communications may include a selectable hyperlink that, when followed by the user, takes the user to a webpage of the third party, not of the legitimate source. To help users quickly determine whether or not messages and links are legitimate, and not attempts at fraud, it may be desirable for a legitimate source to eliminate selectable hyperlinks from such communications, so that users can be informed and assured that communications that include selectable hyperlinks are not from that legitimate source regardless of other appearances.

Instead of including a selectable hyperlink in communications, systems and methods according to the present disclosure may include a non-hyperlinked URL in a communication, along with specific content, that the user can paste or otherwise enter into their browser. When the user's request to access the resource at the URL is received, metadata about the user and about communications sent to the user may be assessed to determine if the user is likely to be responding to a content-specific communication. In response to determining that the user is responding to a content-specific communication, the web server may redirect the user to a webpage specific to the content included in the communication to the user. The content may be, for example, an information topic, an item, etc.

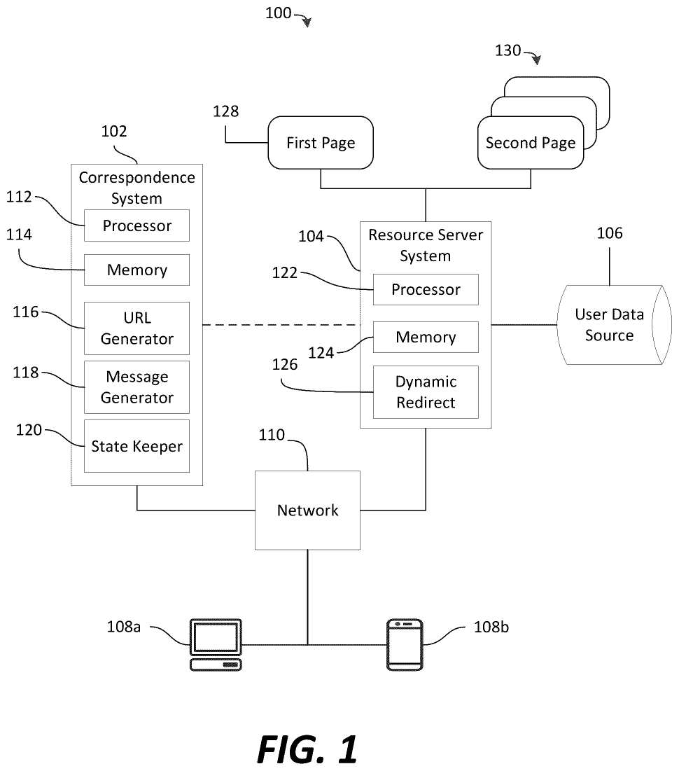

Referring now to the drawings, wherein like reference numerals refer to the same or similar features in the various views, FIG. 1 is a block diagram of an example networked system 100 for serving a resource-specific webpage to a user. The system 100 may include a correspondence system 102, a resource server system 104, and a user data source 106. The correspondence system 102 and resource server system 104 may be in electronic communication with one or more user computing devices 108a, 108b (which may be referred to individually as a user computing device 108, or collectively as used computing devices 108) over a network 110. The correspondence system 102 and resource server system 104 may also be in communication with one another.

The correspondence system 102 may include a processor 112 and a non-transitory, computer-readable memory 114 that contains instructions that, when executed by the processor, cause the correspondence system 102 to perform one or more of the steps, processes, methods, operations, etc. described herein with respect to the correspondence system 102. The correspondence system 102 may include one or more functional modules embodied in the memory. The functional modules may include a URL generator 116, a message generator 118, and a state keeper 120, for example.

The correspondence system 102 may generate and transmit correspondence (e.g., communications) to intended users. Such correspondence may include content, such as a reference to a specific resource, to entice or direct the user to attempt to access that resource or content.

The URL generator 104 may generate a URL for inclusion in the correspondence. The URL may be associated with a given resource, such as a webpage, file, etc. The URL may be, for example, a custom URL specific to the user. Alternatively, the URL may be a generic URL, such as a URL for a home page respective of a domain. The URL generator may generate a URL specific to a user in response to that user's interaction with a communication, in some embodiments, such as in response to a user callback request for a dynamic image in an email.

The message generator 118 may generate (e.g., compose) a message that includes content (e.g., reference to a specific resource) and a URL (e.g., either a generic or user-specific URL). The message may include text that instructs the user to navigate to the URL in order to access the content, for example. The message generator 118 may additionally transmit, or cause to be transmitted, the generated message as a communication to the user. The communication may be, for example, an e-mail, a text message (SMS or MMS), an in-application message (e.g., a “notification” or other message within an application associated with the proprietor of the correspondence system and installed on the user computing device), or some other correspondence form or channel. The communication may be sent from the same domain as is included in the URL, in embodiments. As will be discussed below, the channel through which the communication is transmitted may affect the information used by the system to determine whether to redirect the user in response to the user entering the URL.

The state keeper 120 may receive and store information respective of correspondence to users. For example, for each correspondence, the state keeper may store a sent time, a user read time, a URL included in the correspondence, an indication of the content included in the correspondence, and/or other information respective of the correspondence to enable later determination of whether or not a user's access of the URL is likely to be in response to the correspondence and, if so, later determination of an appropriate resource to serve to the user in respond to the user's attempted access to the URL.

The resource server system 104 may include a processor 122 and a non-transitory, computer-readable memory 124 that contains instructions that, when executed by the processor, cause the resource server system 104 to perform one or more of the steps, processes, methods, operations, etc. described herein with respect to the resource server system 104. The resource server system 104 may include one or more functional modules embodied in the memory. The functional modules may include, for example, a dynamic redirect module 126.

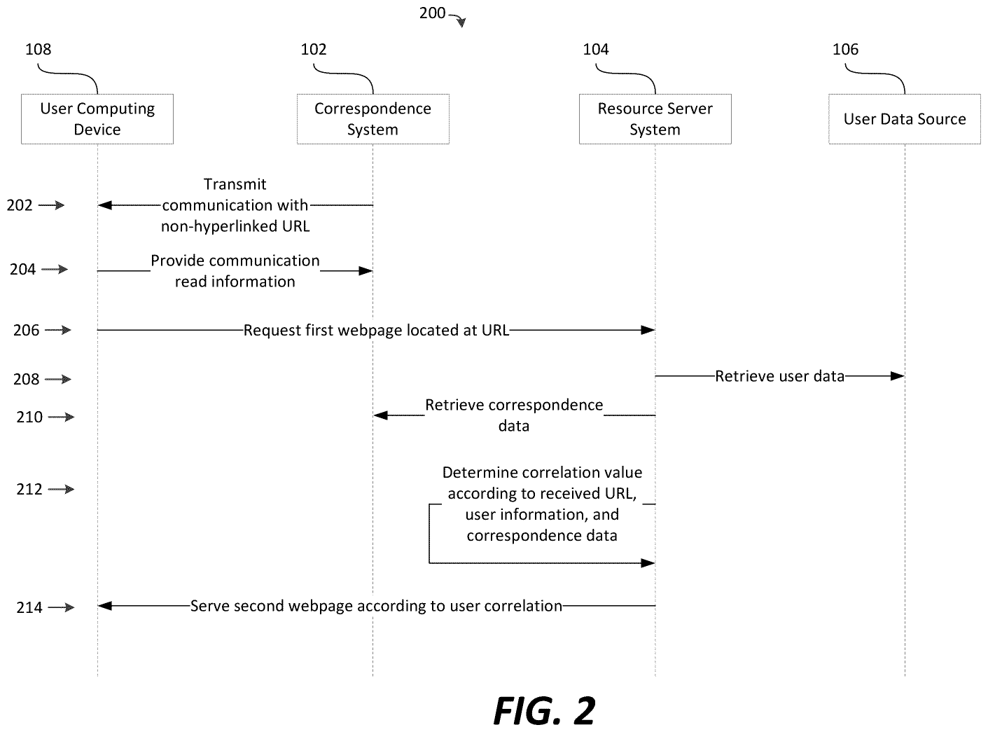

The dynamic redirect module 126 may, in response to receiving a user request to access a resource at a given URL, determine whether that user's request is in response to (e.g., is likely to be in response to) an earlier communication sent to the user (e.g., sent by the correspondence system 102). When the dynamic redirect module 126 determines that the user's request is in response to (e.g., is likely to be in response to) an earlier communication sent to the user, the dynamic redirect module may serve a resource to the user located at a different location than the URL entered by the user (e.g., a different webpage). As will be described in greater detail with respect to FIGS. 2-5, the dynamic redirect module 126 may consider metadata respective of the user (e.g., stored in the user data source), metadata respective of the communication to the user, a time elapsed since the communication was transmitted and/or read, and/or other information to determine whether or not the user's request is in response to an earlier communication sent to the user.

In some embodiments, the resource server system 104 may serve or otherwise host a website located at a domain. The domain may be respective of the proprietor of the resource server system 104 and/or correspondence system 102, in some embodiments. Accordingly, the resource server system 104 may receive a user request to access a first web page 128 located at a first URL and, in response, serve one of one or more second web pages 130 that are different from the first webpage. For example, the first webpage 128 may be a home page of a domain, and each second page 130 may be a sub-page within the domain.

Correspondence may be sent to, and requests may be received from, a variety of user computing devices. For example, a user computing devices may include a mobile device 108b (e.g., cell phone or tablet) or personal computer 108a.

Although shown and described separately, some or all of the functions (e.g., functional modules) of the correspondence system 102 and resource server system 104 may be provided in a single computing system. Similarly, although a single processor 112, 122 and single memory 114, 124 are illustrated for the correspondence system 102 and resource server system 104, respectively, each system 102, 104 may include multiple processors and/or multiple memories that jointly or separately embody the functions of the correspondence system 102 and resource server system 104.

FIG. 2 is a sequence diagram illustrating an example method 200 for serving a resource-specific webpage to a user. The sequence diagram illustrates various operations and communications between a user computing device, the correspondence system, the website server system, and the user data source.

The method 200 includes, at operation 202, the correspondence system 102 transmitting a communication to the user computing device 108, and the user computing device 108 receiving that communication. The communication may include a URL, in some embodiments. The URL may be specific to a certain user, in some embodiments. For example, the URL may be of the form www.[domain].com/[specific], with [specific] being a user-specific portion of the URL. In other embodiments, a given URL may be generated relative to numerous users, which users are different enough from one another that one user's entry of the URL can be accurately associated with that user, as opposed to another user entering the same URL. In other embodiments, the URL may be a generic URL, such as one of the form www.[domain].com.. The URL may be non-hyperlinked in the communication. The communication may further include content, such as a particular item or particular information topic, and an instruction or suggestion to the user to access the URL through the user's browser to access the content.

The correspondence system 102 may have stored, or have access to (e.g., in the user data source 106), data respective of the recipient of the communication. Such recipient data may include, for example, user account information (e.g., respective of an account at the domain from which the correspondence is sent and/or a domain hosted by the resource server system 104), one or more IP addresses associated with the user, one or more locations associated with the user (e.g., derived from IP addresses, location information provided in the user's account, location service information provided by a user computing device, etc.), one or more computing devices associated with the user (e.g., embodied in device identifiers or similar information), one or more operating systems associated with the user, and one or more browsers associated with the user. Accordingly, when the correspondence system 102 transmits a communication to an intended recipient, the correspondence system 102 may associate that communication with the data respective of that recipient (e.g., in or by the state keeper 120 of FIG. 1).

The method 200 further includes, at operation 204, the user computing device 108 transmitting, and the correspondence system 102 receiving, communication read information. The communication read information may include, for example, an IP address, browser information and version, device identifier, location, timestamp, and/or other information respective of the user computing device 108. The user computing device 108 may provide the communication read information by, for example, transmitting a read receipt (where the communication is an in-app message, for example), transmitting a callback request for a dynamic banner image or other dynamic image (where the communication is an email, for example), etc. The correspondence system 102 may store the communication read information as data or metadata associated with the communication, along with metadata generated at the time of transmittal of the communication, such as a sent time.

The method 200 may further include, at operation 206, the user computing device transmitting, and the resource server system 104 receiving, a request to access the resource located at the URL included in the communication of operation 202. For example, a user may have typed or copied the URL into the browser address bar of the user computing device 108. The resource server system 104 may host the domain of the URL entered by the user. The user's request may include, along with the URL, metadata associated with the request, such as information respective of the user computing device 108 submitting the request. Such metadata may be included in header fields of the request, for example. Request metadata may include, for example, the user computing device IP address, a device fingerprint (e.g., identifier), operating system, browser type and version, a location, or other information respective of the user computing device 108.

Although FIG. 2 illustrates the URL request at operation 206 being transmitted by the same user computing device 108 as received the communication at operation 202, a different user computing device 108 may transmit the URL request from the user computing device 108 that received or read the communication. That is, in some embodiments, the communication may be received by a first user computing device 108, and the request may be transmitted by a second user computing device 108, and further operations of the method 200 may include determining whether or not the first and second user computing devices 108 are likely to be associated with the same user.

The method 200 may further include, at operation 208, the resource server system 104 retrieving user data from the user data source 106. The user data retrieval may be performed according the metadata associated with the request received from the user computing device 108. For example, the resource server system may retrieve all information available for the given IP address or device fingerprint associated with the request.

The method may further include, at operation 210, the resource server system 104 retrieving correspondence data associated with one or more communications from the correspondence system 102. The correspondence data may be retrieved according to the user data retrieved at operation 208 and/or according to the request metadata. Operation 210 may include retrieving data associated with one or more communications, including the respective content of those communications, the respective URL including in those communications, and/or respective metadata associated with each of those communications (transmit time, read time, read device IP, etc.).

The method may further include, at operation 212, the resource server system 104 determining a user correlation between data associated with the request of operation 206 and one or more of the communications of which information was retrieved at operation 210. Operation 212 may include calculating a correlation score between one or more users and one or more communications to determine if the request was likely received in response to a communication such that the user wishes to access the content in the communication.

Operation 212 may include calculating a time elapsed between when a communication was sent or read and when the user request to receive the URL is received, in some embodiments. The sooner the request is received after the communication is transmitted or read, the more likely it may be considered that the user is attempting to access the content indicated in the communication. The time elapsed may be a factor in a correlation score (e.g., value), as discussed below.

In some embodiments, operation 212 may include calculating a correlation value, which may be or may include an index indicative of a strength of correlation between two user activities (transmit or read of a communication and submission of a URL) to reflect the likelihood of a user intent to access content in a communication via a URL in the communication. The correlation value may be calculated by comparing the similarity of various data point factors between a communication and a URL request, such as metadata aspects of the communication and the request. That is, the IP, location, device identifier, etc. associated with a communication may be compared to the same information associated with the request to determine a similarity or degree of similarity (e.g., Boolean, percentage, etc.) as to each type of information. The correlation value may be calculated through a weighted combination of the respective similarities of those data point factors. For example, a corresponding logged in session may have a high weight, whereas a similar location (e.g., based on IP address) may have a relatively lower weight. The time elapsed may be assigned a weight based on the amount of that time elapsed, with a shorter amount of time being assigned a greater weight.

Example outcomes of various simplified combinations of factors are provided in table 1 below. In table 1, “First” indicates that, in response to the user request to access the URL, the user is directed to (e.g., served) a first webpage located at the URL, whereas “Second” indicates that, in response to the user request to access the URL, the user is redirected to a second webpage related to the content in the communication to the user. Table 1 is illustrative in nature only, and is not necessarily indicative of a guaranteed outcome for any given combination of user and correspondence data.

TABLE 1

| | | | | Different | | |
|---|---|---|---|---|---|---|
| | Matching | Same IP, | Different | IP, same | Different | Different, |
| Time | device | different OS | fingerprint, | browser | fingerprint, | untrusted |
| elapsed | fingerprint | or browser | but trusted IP | and device | similar location | source |
| <5 mins. | Second | Second | Second | Second | Second | First |
| 5-60 mins. | Second | Second | Second | First | First | First |
| >60 mins. | First | First | First | First | First | First |

The method may further include, at operation 214, the resource server system 104 serving a second webpage to the user computing device 108, which second webpage is located at a URL different from the URL the user attempted to access, according to the user correlation score(s). Operation 214 may include transmitting data respective of the second webpage to an origin of the request, such as the user computing device 108.

The method 200 advantageously enables an entity to send communications to a user with “links” to content, and the user can engage with the content without risk of a fraudulent link because the user must input the URL into their own browser. As a result, the entity can send targeted content communications to users and appropriately serve that content to users while enabling those users to easily distinguish legitimate messages from the entity from fraudulent messages from third parties.

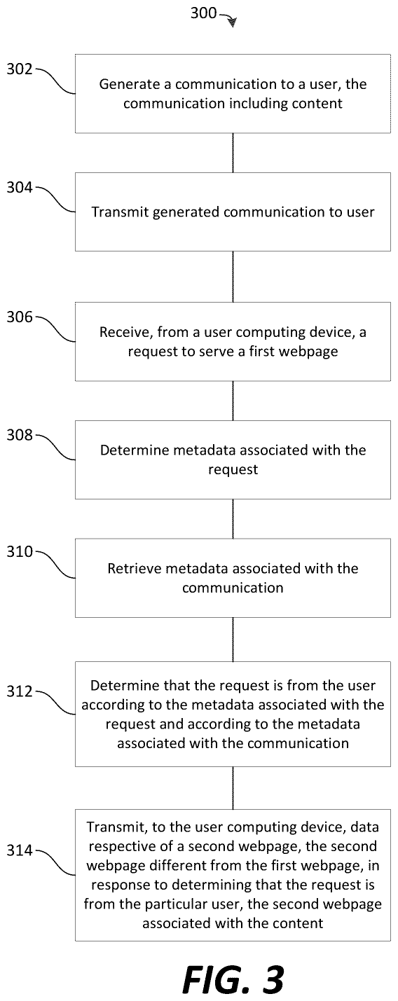

FIGS. 3-6 are flow charts illustrating example embodiments of dynamic redirects according to the approach of the method 200, in which the use of variations in communication type, user data, and correspondence data are discussed.

FIG. 3 is a flow chart illustrating an example method of serving a resource-specific webpage to a user. The method 300, or one or more portions thereof, may be performed by the correspondence system 102 and/or the resource server system 104, in some embodiments.

The method 300 may include, at block 302, generating a communication to a user, the communication including content. The communication may include a URL and the content may include, for example, a description of an item, informational topic, or other resource accessible via the URL. The URL may be a non-hyperlinked URL for a first resource, such as a first webpage, in some embodiments. The first webpage may be, for example, a home page for a domain (e.g., www.[domain].com). The URL may be a customized URL for the intended recipient user of the communication, in some embodiments.

The method 300 may further include, at block 304, transmitting the generated communication to the user. The communication may be sent as one or more of a text message, an email, or an in-application message, or through another appropriate communication channel.

The method 300 may further include, at block 306, receiving, from a user computing device, a request to serve a first webpage. The request may be an HTTP request. The request may include the URL included in the communication. The first webpage may be a home page of a domain, in some embodiments.

The method 300 may further include, at block 308, determining metadata associated with the request. The request may have included such metadata, for example in one or more headers of the request. The metadata may include, for example, an IP address, a browser identifier, a browser version, a device identifier, and/or a timestamp at which the request was received.

The method 300 may further include, at block 310, retrieving metadata associated with the communication. The metadata may include, for example, an IP address of the recipient, a browser identifier associated with the recipient, a browser version associated with the recipient, a device identifier associated with the recipient, and/or a timestamp associated with the transmission or user reading of the communication. In some embodiments, block 310 may include retrieving metadata associated with a plurality of communications according to the request and metadata associated with the request.

The method 300 may further include, at block 312, determining that the request is from the user according to the metadata associated with the request and according to the metadata associated with the communication. Block 312 may include calculating correlation scores between the user request and one or more communications, which one or more communications include the communication transmitted at block 304. The correlation scores may be calculated as described with respect to FIG. 2 above. Block 312 may include comparing the calculated correlation score(s) to a threshold and determining that the correlation score associated with the communication exceeds the threshold, in some embodiments.

The method 300 may further include, at block 314, transmitting, to the user computing device, data respective of a second webpage, the second webpage different from the first webpage, in response to determining that the request is from the particular user. The second webpage may be associated with the content in the communication transmitted at block 304. The second webpage may be a sub-page within the domain of the first page, in some embodiments (e.g., www.[domain].com/[sub-page]). The data transmitted may be sufficient for the user computing device to display the second webpage, in some embodiments.

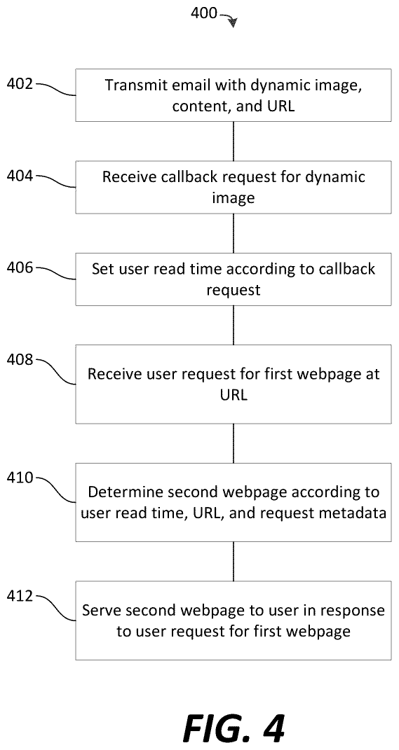

FIG. 4 is a flow chart illustrating an example method 400 of serving a resource-specific webpage to a user. FIG. 4 illustrates an example in which email is a communication channel for sending the communication to the user. The method 400, or one or more portions thereof, may be performed by the correspondence system 102 and/or the resource server system 104, in some embodiments.

The method 400 may include, at block 402, transmitting an email, to a user, that includes a dynamic image, content, and a URL. The dynamic image may be, for example, a banner image for the email. The dynamic image may be one intended to be served at the time that the user opens the email. The content and URL may be as described above with respect to the methods 200, 300, in some embodiments. Alternatively, the URL may be included in the dynamic image, and thus may be transmitted to the user at the time the user opens the email in response to a callback request, as described below.

The method 400 may further include, at block 404, receiving a callback request for the dynamic image. The callback request may be received from a user computing device with which the user opens the email. The callback request may include metadata for the user computing device, and such metadata may therefore be associated with the communication and with user interaction with the communication. In response to the callback request, an image may be transmitted to the user computing device for display in the email. In some embodiments, a URL may be included in the image.

The method 400 may further include, at block 406, setting and storing a user read time according to the callback request. For example, the user read time may be set to be equal to a timestamp of the callback request. The user read time may be used as a basis for determining a correlation between the user communication and a later user request to access a resource at the URL included in the email.

The method 400 may further include, at block 408, receiving a user request for a first webpage at the URL included in the email. The request may be an HTTP request that includes metadata, including a time that the request is transmitted by the user computing device and information respective of the user computing device that transmitted the request.

The method 400 may further include, at block 410, determining a second webpage according to the user read time, the URL received at block 408, and metadata associated with the request. For example, block 410 may include calculating a time elapsed from the user read time to the time that the user computing device transmitted the request. Block 410 may include calculating a correlation score between the user request and one or more communications, with the time elapsed as a weight applied to various time elapsed values associated with respective communications. The weight to associate based on time elapsed may be based on one or more predefined amounts of time (e.g., less than 5 minutes, 5-60 minutes, or more than 60 minutes). As a result, block 410 may include determining that the request is received within a predefined time period after the user read time.

The method 400 may further include, at block 412, serving a second webpage to the user in response to user request for first webpage. Serving the second webpage may be further responsive to the determinations made at block 410. The second webpage may be associated with (e.g., may include) the content in the email sent to the user at block 402.

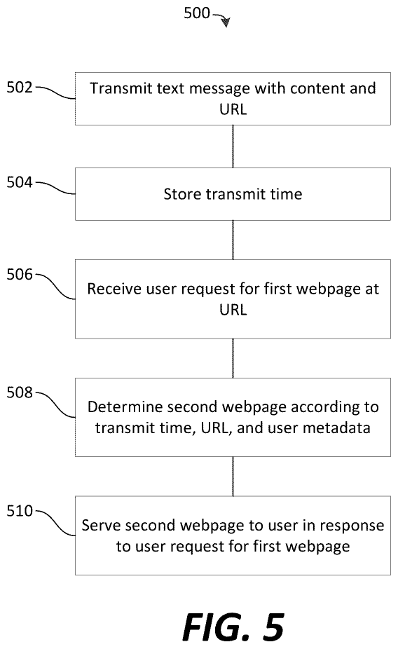

FIG. 5 is a flow chart illustrating an example method of serving a resource-specific webpage to a user. FIG. 5 illustrates an example in which a text message is the communication channel for sending the communication to the user. The method 500, or one or more portions thereof, may be performed by the correspondence system or the resource server system, in some embodiments.

The method 500 may include, at block 502, transmitting a text message to a user with content and a URL and, at block 504, storing the transmit time of the text message. The transmit time may be used to make time elapsed calculations for correlation scores in conjunction with text messages and/or other correspondence for which a user read time may not be available, in some embodiments.

The method 500 may further include, at block 506, receiving a user request for a first webpage at the URL included in the email. The request may be an HTTP request that includes metadata of the request, including a time that the request is transmitted by the user computing device.

The method 500 may further include, at block 508, determining a second webpage according to the communication transmit time, the URL received at block 506, and metadata associated with the request. For example, block 508 may include calculating a time elapsed from the transmit time to the time that the user computing device transmitted the request. Block 508 may include calculating a correlation score between the user request and one or more communications, with the time elapsed as a weight applied to various time elapsed values associated with respective communications. The weight to associate based on time elapsed may be based on one or more predefined amounts of time. As a result, block 508 may include determining that the request is received within a predefined time period after the transmit time.

The method 500 may further include, at block 510, serving a second webpage to the user in response to user request for first webpage. Serving the second webpage may be further responsive to the determinations made at block 508. The second webpage may be associated with (e.g., may include) the content in the text message sent to the user at block 502.

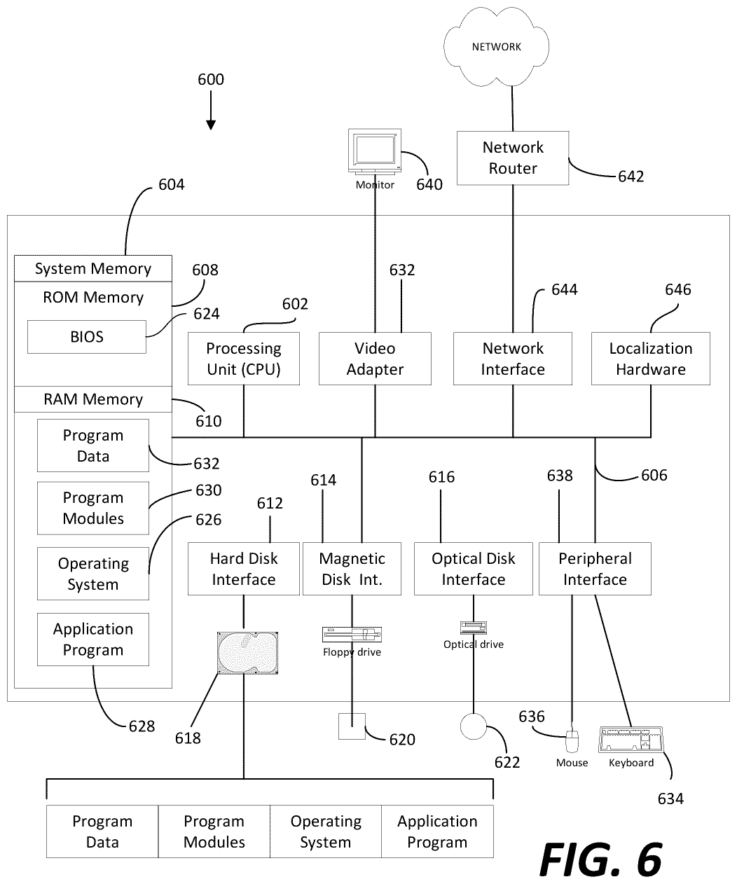

FIG. 6 is a block diagram of an example computing system, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628, other program modules 630, and/or program data 632. Still further, computer-executable instructions may be downloaded to the computing environment 600 as needed, for example, via a network connection. The applications programs 628 may include, for example, a browser, including a particular browser application and version, which browser application and version may be relevant to determinations of correspondence between communications and user URL requests, as described herein. Similarly, the operating system 626 and its version may be relevant to determinations of correspondence between communications and user URL requests, as described herein.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 632. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 642, that is responsible for network routing. Communications with the network router 642 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600. Data from the localization hardware 646 may be included in a callback request or other user computing device metadata in the methods of this disclosure.

The computing system, or one or more portions thereof, may embody a user computing device 108, in some embodiments. Additionally or alternatively, some components of the computing system 600 may embody the correspondence system 102 and/or resource system server 104. For example, the functional modules 116, 118, 120, 126 may be embodied as program modules 630.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method comprising:
generating, by a computing system, a communication to a user, the communication including content;
receiving, by a server system, from a user computing device, a request to serve a first webpage;
determining, by the server system, metadata associated with the request;
retrieving, by the server system, metadata associated with the communication;
determining, by the server system, that the request is from the user according to the metadata associated with the request and according to the metadata associated with the communication; and
transmitting, by the server system to the user computing device, data respective of a second webpage, the second webpage different from the first webpage, in response to determining that the request is from the user, the second webpage associated with the content.

2. The method of claim 1, wherein the communication is one of:
an SMS message;
an email; or
an in-application message.

3. The method of claim 1, wherein the communication comprises a non-hyperlinked URL for the first webpage.

4. The method of claim 3, wherein receiving the request to serve the first webpage comprises receiving the URL.

5. The method of claim 1, wherein the metadata associated with the request or the metadata associated with the communication comprises one or more of:
an IP address;
a browser identifier;
a browser version;
a device identifier; or
a timestamp.

6. The method of claim 1, further comprising:
determining that the request is received within a predefined time period after the communication was transmitted to the user;
wherein transmitting data respective of the second webpage is further in response to the determining that the request is received within a predefined time period after the communication was transmitted to the user.

7. The method of claim 1, wherein the metadata associated with the communication comprises a user read time of the communication, the method further comprising:
determining that the request is received within a predefined time period after the user read time;
wherein transmitting data respective of the second webpage is further in response to the determining that the request is received within a predefined time period after the user read time.

8. The method of claim 1, further comprising:
receiving, by the computing system after the communication is transmitted, a callback request to serve an image for the communication; and
transmitting, by the computing system in response to the callback request, an image that includes a non-hyperlinked URL for the first webpage;
wherein the request comprises the URL.

9. The method of claim 8, further comprising:
determining, by the computing system in response to the callback request, a custom URL;
wherein the non-hyperlinked URL for the first webpage comprises the custom URL.

10. A system comprising:
a processor; and
a non-transitory computer-readable medium having stored thereon instructions that are executable by the processor to cause the system to perform operations comprising:
receiving metadata associated with interaction by a user with an electronic communication, the communication comprising a non-hyperlinked URL for a first webpage;
receiving, from a user computing device, a request to serve the first webpage;
determining that the request is from the user according to the request and according to the metadata associated with the user interaction with the communication; and
transmitting, to the user computing device in response to the request and in response to determining that the request is from the user, data respective of a second webpage that is different from the first webpage.

11. The system of claim 10, wherein the metadata associated with the user interaction with the communication comprises one or more of:
an IP address of the user interaction;
an identifier of a device used for the user interaction; or
a timestamp of the user interaction.

12. The system of claim 10, wherein receiving metadata associated with interaction by a user with an electronic communication comprises one or more of:
receiving a callback request to serve an image associated with the communication; or
receiving a read receipt for the communication.

13. The system of claim 12, wherein the non-transitory computer-readable medium stores further instructions that are executable by the processor to cause the system to perform operations comprising:
determining that the request is received within a predefined time period after receiving the callback request or receiving the read receipt;
wherein redirecting the user to the second webpage is further in response to determining that the request is received within a predefined time period after receiving the callback request or receiving the read receipt.

14. The system of claim 10, wherein determining that the request is from the user according to the request comprises determining that the request is from the user according to metadata associated with the request, wherein the metadata associated with the request comprises one or more of:
an IP address of a source of the request;
a browser of a source of the request;
a version of a browser of a source of the request;
an identifier of a source device of the request; or
a timestamp of the request.

15. The system of claim 10, wherein the non-transitory computer-readable medium stores further instructions that are executable by the processor to cause the system to perform operations comprising:
determining that the request is received within a predefined time period after transmitting the communication;
wherein redirecting the user to the second webpage is further in response to determining that the request is received within a predefined time period after transmitting the communication.

16. The system of claim 10, wherein:
the non-hyperlinked URL for the first webpage is a custom URL; and
determining that the request is from the user according to the request comprises determining that the request is from the user according to the custom URL.

17. A method comprising:
transmitting, by a computing system, a communication to a user, the communication including a non-hyperlinked URL;
receiving, by a server system, a request to serve a resource located at the URL;
determining, by the server system, that the request is from the user according to the URL and according to metadata associated with the communication; and
transmitting, by the server, to an origin of the request, in response to the request and in response to determining that the request is from the user, data respective of a webpage that is not located at the URL.

18. The method of claim 17, further comprising:
receiving metadata associated with user interaction with the communication;
wherein the metadata associated with the communication comprises the metadata associated with user interaction with the communication.

19. The method of claim 18, further comprising:
determining that the request is received within a predefined time period after the user interaction with the communication;
wherein redirecting the user to the webpage is further in response to determining that the request is received within a predefined time period after the user interaction with the communication.

20. The method of claim 17, wherein the URL is a custom URL specific to the user.
